(19) United States
(12) Patent Application Publication
(10) Pub. No.: US 2024/0153007 A1
(43) Pub. Date: May 9, 2024

(54) OPTIMIZATION USING A PROBABILISTIC FRAMEWORK FOR TIME SERIES DATA AND STOCHASTIC EVENT DATA

(71) Applicant: INTERNATIONAL BUSINESS MACHINES CORPORATION, Armonk, NY (US)

(72) Inventors: Yada Zhu, Westchester, NY (US); Yang Zhang, Cambridge, MA (US); Tian Gao, Berkeley Heights, NJ (US); David Cox, Somerville, MA (US)

(21) Appl. No.: 17/978,486

(22) Filed: Nov. 1, 2022

(51) Int. Cl. G06Q 40/06

(52) U.S. Cl. CPC G06Q 40/06

(57) ABSTRACT

A method includes: creating a training data set based on user input, the training data set including time series data of a price of an asset and stochastic event data of events related to the asset; creating an event intensity model that models an event intensity parameter of one of the events related to the asset, wherein the event intensity model comprises a proximal graphical event model (PGEM), and the creating the event intensity model includes learning parameters of the PGEM using machine learning and the training data set; creating a probabilistic time series model that predicts a probability distribution of a return of the asset, wherein the creating the probabilistic time series model includes learning parameters of the probabilistic time series model using machine learning and the training data set; and predicting a future return of the asset for a future time period using the probabilistic time series model.

### BACKGROUND

Aspects of the present invention relate generally to computer-based modeling and probabilistic time series forecasting and, more particularly, to portfolio optimization using a probabilistic framework for time series data and stochastic event data.

A time series is a collection of random variables observed sequentially at fixed intervals of time and is of interest in the fields of finance and artificial intelligent (AI). Learning from time series provides valuable insights for market movement, future stock return, and correlations that are usable for investment decision making. In contrast to time series, event streams are sequences of events of various types that typically occur as irregular and asynchronous continuous-time arrivals.

### STATEMENT REGARDING PRIOR DISCLOSURES BY THE INVENTOR OR A JOINT INVENTOR

The following disclosure(s) are submitted under 35 U.S.C. 102(b)(1)(A):
DISCLOSURE: “Probabilistic Framework for Modeling Event Shocks to Financial Time Series,” Zhu et al., presented Nov. 3-5, 2021 at ICAIF'21, 8 pages. This document is listed in the accompanying IDS.

### SUMMARY

In a first aspect of the invention, there is a computer-implemented method comprising: creating, by a processor set, a training data set based on user input, the training data set including time series data of a price of an asset and stochastic event data of events related to the asset; creating, by the processor set, a probabilistic framework for modeling event intensity, event magnitude, and their effects on a probabilistic time series of a return of the asset by: creating, by the processor set, an event intensity model that models an event intensity parameter of one of the events related to the asset, wherein the event intensity model comprises a proximal graphical event model (PGEM), and wherein the creating the event intensity model comprises learning parameters of the PGEM using machine learning and the training data set; and creating, by the processor set, a probabilistic time series model that predicts a probability distribution of a return of the asset, wherein the creating the probabilistic time series model comprises learning parameters of the probabilistic time series model using machine learning and the training data set; and predicting, by the processor set, a future return of the asset for a future time period using the probabilistic time series model.

In another aspect of the invention, there is a computer program product comprising one or more computer readable storage media having program instructions collectively stored on the one or more computer readable storage media, the program instructions executable to: create a training data set based on user input, the training data set including time series data of a price of an asset and stochastic event data of events related to the asset; create a probabilistic framework for modeling event intensity, event magnitude, and their effects on a probabilistic time series of a return of the asset by: creating an event intensity model that models an event intensity parameter of one of the events related to the asset, wherein the event intensity model comprises a proximal graphical event model (PGEM), and wherein the creating the event intensity model comprises learning parameters of the PGEM using machine learning and the training data set; and creating a probabilistic time series model that predicts a probability distribution of a return of the asset, wherein the creating the probabilistic time series model comprises learning parameters of the probabilistic time series model using machine learning and the training data set; and predict a future return of the asset for a future time period using the probabilistic time series model.

In another aspect of the invention, there is system comprising a processor set, one or more computer readable storage media, and program instructions collectively stored on the one or more computer readable storage media, the program instructions executable to: create a training data set based on user input, the training data set including time series data of a price of an asset and stochastic event data of events related to the asset; create a probabilistic framework for modeling event intensity, event magnitude, and their effects on a probabilistic time series of a return of the asset by: creating an event intensity model that models an event intensity parameter of one of the events related to the asset, wherein the event intensity model comprises a proximal graphical event model (PGEM), and wherein the creating the event intensity model comprises learning parameters of the PGEM using machine learning and the training data set; and creating a probabilistic time series model that predicts a probability distribution of a return of the asset, wherein the creating the probabilistic time series model comprises learning parameters of the probabilistic time series model using machine learning and the training data set; and predict a future return of the asset for a future time period using the probabilistic time series model.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the invention.

FIG. 3 shows an exemplary user interface in accordance with aspects of the invention.

FIG. 4 shows a diagram of an exemplary system for portfolio optimization in accordance with an embodiment of the invention.

FIG. 5 shows a diagram of an exemplary system for portfolio optimization in accordance with an embodiment of the invention.

FIGS. 6A, 6B, and 6C show exemplary outputs comprising causal relationship graphs in accordance with aspects of the invention.

FIG. 6D shows an exemplary output comprising portfolio performance in accordance with aspects of the invention.

FIG. 7 shows a flowchart of an exemplary method in accordance with aspects of the invention.

FIG. 8 shows a flowchart of an exemplary method in accordance with aspects of the invention.

### DETAILED DESCRIPTION

Aspects of the present invention relate generally to computer-based modeling and probabilistic time series forecasting and, more particularly, to portfolio optimization using a probabilistic framework for time series data and stochastic event data. In financial markets, certain types of stochastic events are impactful to the prediction of financial times series, such as stock return, while few existing research attempts have been made to incorporate stochastic event modeling to time series modeling in a principled way. Moreover, financial portfolio management and investment decisions are still largely based on restricted assumptions such as past probability distribution of assets' returns fully representing the future, i.e., constant distribution. As such, current techniques for stock price prediction and portfolio management fail to account for the impact of stochastic events on the time series data. Current techniques do not adequately account for the sophisticated temporal interaction among different stochastic events and their shock effects to time series, which can also have temporal cross-correlations for multivariate time series.

Embodiments of the invention address these problems by providing a probabilistic framework including probabilistic models that capture the inter-dependencies among stochastic events, and the impact of these events on time series. Embodiments extend multivariate Hawkes processes (MHP) and proximal graphical event models (PGEM) and apply this framework to modeling financial events (e.g., company quarterly revenue releases and updates of consensus prediction of quarterly revenue) and their impacts on the mean and correlation structures of future stock return. Embodiments may utilize the probabilistic framework to estimate a dynamic variance-covariance matrix. In this manner, a probabilistic framework according to aspects of the invention improves prediction of financial time series and promotes AI trust for finance by revealing the causal relationship among the events.

According to aspects of the invention, a method incorporates the impact of stochastic events into multivariate time series modeling and demonstrates its application in capturing effects of events on stock return and correlation prediction. Embodiments include a probabilistic framework to model event intensity, event magnitude, and their effects to the distribution of stock return.

In one embodiment of the probabilistic framework, event intensity is modeled using a new proximal graphical event model (PGEM). In embodiments, PGEM is used to learn historical impacts on events from a short window in the most recent past. PGEM may be used in this manner to learn not only the density of event occurrence but also event causal relationship, which provides the benefit of shedding light on AI trust for finance. The probabilistic framework may also be used to learn event causal relationships. In embodiments, a method uses output generated by one or more models of the probabilistic framework to perform portfolio optimization. The output may include times series forecasting data and may be used to present event causal relationship to interpret asset correlations, predict future values of the input financial indicators, and construct and optimize portfolios.

In another embodiment of the probabilistic framework, event intensity is modeled using a multivariate process that accounts for domain knowledge. In one example, the multivariate process is a multivariate Hawkes process. In embodiments, this process captures event impact through the entire history of a time series and captures dynamic event impact to the mean and variance-covariance matric of return distributions. In embodiments, a method uses output generated by one or more models of the probabilistic framework to perform for portfolio optimization. The output may include an estimated distribution of a financial times series and may be used to present event causal relationship to predict future values of the input financial indicators, estimate the asset risk based on the dynamic variance-covariance matrix, and improve portfolio optimization by accounting for the impact of key stochastic market events.

There are no current systems or methods that account for the impact of stochastic financial events in computer-based modeling of a financial time series. As such, current systems and methods that use computer-based modeling of a financial time series to predict future stock price (or stock return) are unreliable when the stock price (or return) is affected by a stochastic financial event, such as company revenue releases and updates of consensus prediction of revenue. Implementations of the invention provide a technical solution to this technical problem in computer-based modeling of a financial time series by providing a probabilistic framework that models the impact of stochastic financial events on the financial time series. In embodiments, the probabilistic framework includes computer-based models that model stochastic financial event intensity, stochastic financial event magnitude, and time series distribution that is based in part on the event intensity and/or event magnitude. In embodiments, the models are generated using machine learning. In one example, the system learns parameters for different models in the probabilistic framework using training data sets and machine learning algorithms such as maximum likelihood estimation algorithms. The training data sets are so large, and the learning algorithms are so complex, that such learning can only be performed using computer-based machine learning and cannot be performed manually (e.g., in the human mind or with pen and paper).

Implementations of the invention provide an improvement in the field of computer-based modeling and probabilistic time series forecasting. For example, by accounting for the effects of stochastic events in the inventive machine learning models (e.g., the probabilistic time series model that predicts a probability distribution of a return of the asset), the probabilistic framework in accordance with aspects of the invention creates a new and more accurate probabilistic time series model that improves the accuracy of the time series prediction compared to current systems or methods that do not account for the impacts of stochastic events. Implementations of the invention also provide a technological contribution in the field of computer-based modeling and probabilistic time series forecasting. For example, implementations of the invention include a method, system, and computer program product that: cause a user computing device to display a graphic user interface that receives user input defining assets, constraints, and optimization objectives; create a probabilistic framework including training new machine learning models based on the user input; use the probabilistic framework to generate a portfolio optimization based on the user input; and cause the user computing device to display the generated portfolio optimization via the graphic user interface from which the user input was received.

It should be understood that, to the extent implementations of the invention collect, store, or employ personal information provided by, or obtained from, individuals (for example, personal financial information), such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as probabilistic forecasting and optimization code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

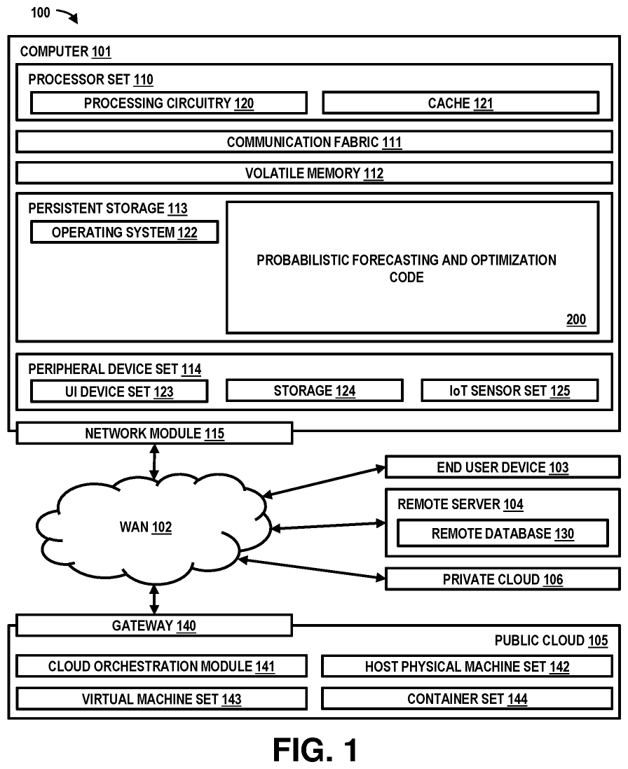

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

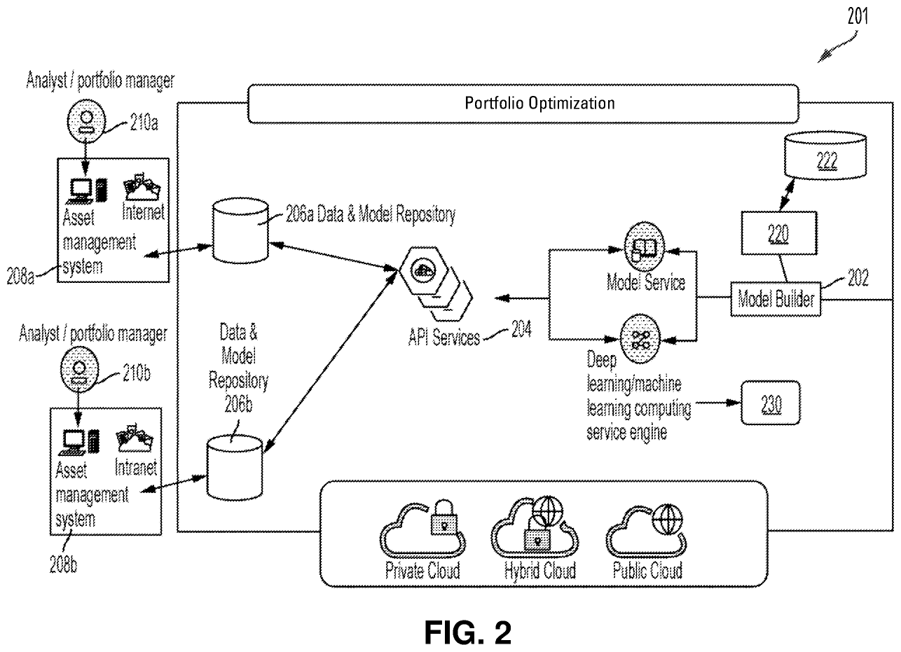

FIG. 2 is a diagram illustrating an example of computer system architecture that can implement a portfolio management system in one embodiment. The system 201 can be a cloud-based system, such as a computing system being implemented by a cloud-computing platform. In another example, the system can be a server-based system. The system can include a processor set 220 configured to be in communication with a memory 222. The processor set 220 may be part of the processor set 110 of FIG. and the memory 222 can be part of the volatile memory 112 and/or persistent storage 113 of FIG. 1. The processor set 220 can execute code such as probabilistic forecasting and optimization code 200 of FIG. 1 to perform one or more functions described herein.

The system 201 can further include a model builder 202, one or more application programming interface(s) (API) 204, one or more data model repositories 206a, 206b, and one or more asset management systems 208a, 208b. In some examples, the data model repositories 206a, 206b can be parts (e.g., memory partitions) of the memory 222. The model builder 202 can be implemented by the processor set 220. The model builder 202 can include the probabilistic forecasting and optimization code 200 of FIG. 1. The processor set 220 can be configured to implement the model builder 202 to build models 230 described herein, including but not limited to an event intensity model, an event magnitude model, and a time series distribution model. In some examples, one or more components of the system can be components of a cloud computing platform.

The APIs 204 can be implemented by a plurality of devices that belong to a plurality of domains, and the APIs 204 can output data of a respective domain. For example, a weather API can be implemented by a server of a weather forecast platform to provide weather-related data to the system 201. The data output by the APIs 204 can be received at the processor set 220, and the processor set 220 (or model builder 202) can use the data output by the APIs 204, e.g., in addition to historical data corresponding to one or more assets, to learn the models 230. The data being output by the APIs 204 can be stored in the memory 222 and/or the data model repositories 206a, 206b.

The asset management systems 208a, 208b can be configured to access data stored in the data model repositories 206a, 206b. The asset management systems 208a, 208b can be operated by respective end users. For example, an end user 210a can operate the asset management system 208a and an end user 210b can operate the asset management system 208b. An asset management system (e.g., 208a) can be implemented as a portfolio management system to manage a portfolio including a plurality of assets (e.g., equities, stocks, investment products, etc.). The asset management system 208a can provide a platform for an end user to generate a portfolio and to determine various performance metrics of the generated portfolio. Further, the asset management system 208a can provide a platform for an end user to determine various performance metrics of a particular asset. For example, an end user can select and/or upload one or more assets, and the processor set 220 can apply or run the models 230 to generate various performance metrics of the selected or uploaded assets. Some examples of these performance metrics can include a forecast of revenue growth, earnings, asset future, benchmark portfolio performance, returns, and/or other performance metrics such as portfolio volatility and Sharpe ratio. Further, the performance metrics being output by the application of the models 230 can include time-series data, such that forecasted performance metrics across different time epochs can be presented or displayed to the end users via the asset management systems 208a, 208b.

In an example, the processor set 220 and the memory 222 can be components of a cloud computing platform configured to provide applications that may be necessary to run the asset management systems 208a, 208b on a plurality of end user devices. The processor set 220 and the end user devices can be communication nodes of a computer network, where data relating to these asset management applications can be communicated among these communication nodes. The APIs 204 can be implemented by a plurality of computer devices associated with different domains. The system 201 can be formed by integrating the computer devices, which are implementing the APIs 204, into the computer network as new communication nodes. The processor set 220 can utilize data provided by the APIs 204 to implement the system 201 and the methods being described herein. Further, the processor set 220 can be integrated with, for example, the model builder 202, to process the data obtain from the APIs 204 and use the processed data to generate machine-readable training data that can be used by the processor set 220 to develop and learn parameters for the models 230 using the methods described herein. The models 230 can output to the asset management system 208a to be used in portfolio optimization as described herein.

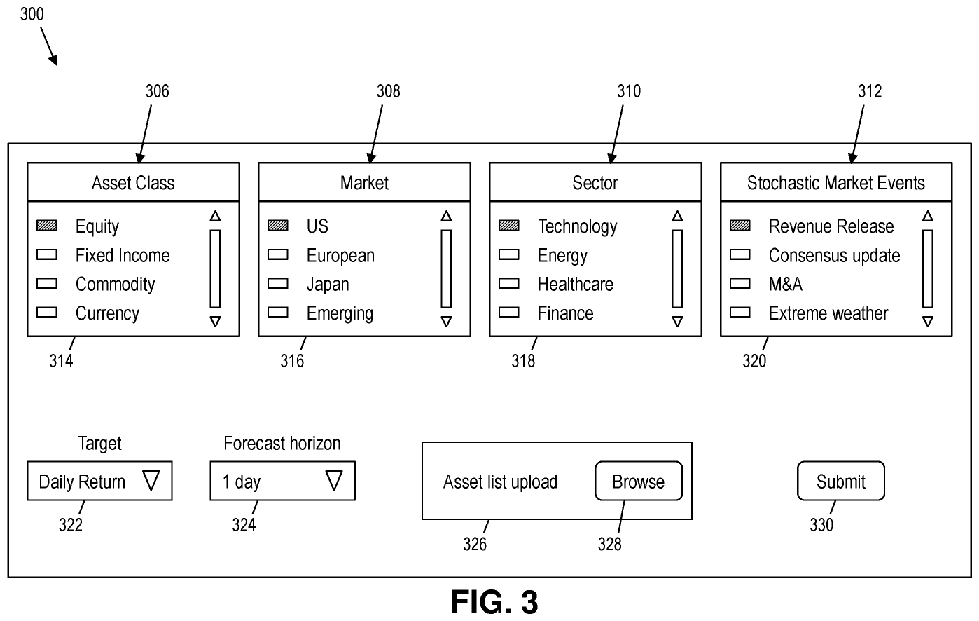

In an embodiment, the asset management system 208a can include a user interface such as a graphical user interface (GUI) for interacting with a user 210a. FIG. 3 illustrates an example of a GUI 300 that allows end users to perform portfolio optimization functions using models generated in accordance with aspects of the invention. Components presented on the GUI 300 can include interactive components, which a user can select, click, and enter input. The GUI 300 can allow a user to specify various parameters associated with the assets the user would like to include in a portfolio while performing portfolio optimization analysis. For instance, the GUI 300 can allow a user to enter an asset class 306, market type 308, sector 310, and events 312 via interactive menus 314, 316, 318, 320. In embodiments, the GUI 300 includes a field 322 by which a user can provide input to specify a target parameter for portfolio optimization and a field 324 by which a user can provide input to specify a forecast horizon for the for portfolio optimization. In embodiments, the GUI 300 includes a field 326 by which a user can provide input to select an asset list comprising one or more assets from an asset universe. The GUI 300 can allow a user to upload an asset list, for example, saved as a file. For instance, selecting or clicking on a browse button 328 or like GUI element can allow a user to navigate to a directory or folder and upload a file. In another example, an input field can be provided for allowing a user to enter a file name to upload. Via the GUI 300, a user can select or directly upload asset list for constructing a portfolio. Selecting or clicking on a submit button 330 or like GUI element triggers the input data to be communicated, for example, sent to a data and model repository (FIG. 2, 206a) for storing and for a processor (FIG. 2, 220) to retrieve and perform portfolio optimization data generation.

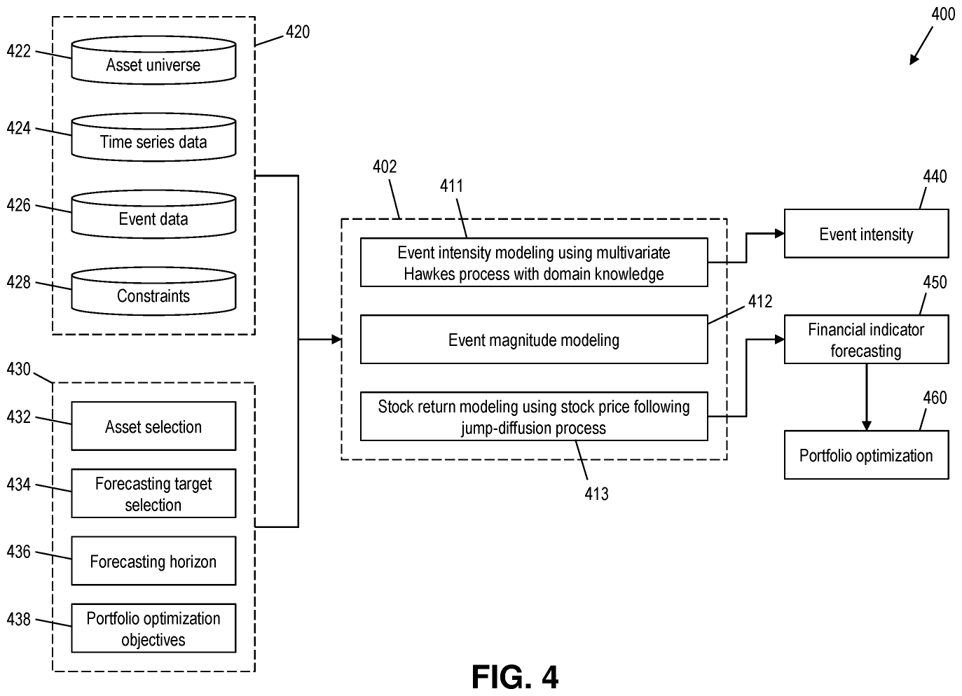

FIG. 4 shows a diagram of system 400 for portfolio optimization in accordance with aspects of the invention. In embodiments, the system 400 includes code 402 configured to generate a probabilistic framework comprising probabilistic models including an event intensity model, an event magnitude model, and a stock return model. In embodiments, the code 402 comprises modules including: a first module 411 configured to perform event intensity modeling using multivariate Hawkes process with domain knowledge; a second module 412 configured to perform even magnitude modeling; and a third module 413 configured to perform stock return modeling using stock price following jump-diffusion process. Each of the modules 411, 412, 413 may comprise one or more modules of the code of block 200 of FIG. 1 and may be executable by the processing circuitry 120 of FIG. 1 to perform functions described herein. In an embodiment, the code 402 is part of the model builder 202 of FIG. 2. The code 402 may include additional or fewer modules than those shown in FIG. 4. In embodiments, separate modules may be integrated into a single module. Additionally, or alternatively, a single module may be implemented as multiple modules.

In embodiments, the system 400 comprises data sources 420 including asset universe 422, time series data 424, event data 426, and constraints 428. The system 400 may also utilize user inputs 430 that specify an asset selection 432, forecasting target selection 434, forecasting horizon 436, and portfolio optimization objectives 438. The data sources 420 may comprise data stored in repository 206a, 206b of FIG. 2. The asset universe 422 may comprise data defining all the candidate financial assets for constructing a portfolio. The time series data 424 may comprise historic time series data for respective ones of the assets included in the asset universe 422. The event data 426 may comprise historical data of stochastic financial events associated with respective ones of the assets included in the asset universe 422. For example, one asset of plural assets in the asset universe 422 might be the stock of Company A. In this example, the time series data 424 may include historic daily stock prices for the stock of Company A, and the event data 426 may include historic reported revenue of Company A (e.g., released by Company A) and historic consensus adjustments of Company A (e.g., aggregated from sources independent of Company A, such as third-party financial analysts).

As used herein, a time series variable, X, refers to a collection of random variables corresponding to every time step. Formally, X={Xᵢₜ}, where t represents the time step (whose temporally granularity is by day, for example), and i represents the company. In embodiments, d denotes the number of companies considered and T denotes the time horizon. As used herein an event variable, E, models financial variables that occur sporadically, i.e., do not have observations at all the time steps. Therefore, each event is associated with two variables, the time variable, which depicts the time step when the event happens, and the magnitude variable, which depicts the magnitude of the event. Formally, E={lᵢₙ, Eᵢₙ, tᵢₙ}, where n denotes the event index, lᵢₙ is the label of the n^{th} event, (e.g., lᵢₙ=z for company release and lᵢₙ=c for consensus correction), Eᵢₙ denotes the magnitude of the n^{th} event, and tᵢₙ denotes the time of the n^{th} event.

In embodiments, the event data 426 includes data defining company revenue, denoted as Z, which refers to the quarterly revenue released by each public company, which is a key indicator of the valuation and profitability of a company and used to project future stock returns by investors. Company revenue is considered as an event variable; hence Z is represented according to Expression 1:

Z={z, Zᵢₙ, tᵢₙ^{Z}} (1)
In Expression 1, Zᵢₙ represents the magnitude of the revenue release and tᵢₙ^{Z} represents the time of the revenue release.

In embodiments, the event data 426 includes data defining consensus adjustment (also called consensus update), denoted by C, which refers to the aggregated revenue estimation of the upcoming quarters by multiple stock analysts. Consensus usually remains constant until it is adjusted sporadically, so it is considered as an event variable; hence C is represented according to Expression 2:

C={c, Cᵢₙ, tᵢₙ^{C}} (2)
In Expression 2, Cᵢₙ represents the value of the consensus adjustment and tᵢₙ^{C} represents the time of the consensus adjustment.

In embodiments, the time series data 424 includes data defining historic stock price, denoted by S, which refers to the daily closing stock price of a company. Stock price is a time series variable; hence S is represented by S={Sᵢₜ}. Stock return, denoted by R, is a function of stock price and is a time series variable; hence R is represented by R={Rᵢₜ}. Stock return may be defined according to Expression 3:

$${R}_{it} = \frac{{S}_{it}}{{S}_{i ( t - 1 )}} - 1 \qquad ( 3 )$$

According to aspects of the invention, the code 402 of system 400 obtains (e.g., from the time series data 424) historic stock price data for an asset included in the asset universe 422. The code 402 also obtains (e.g., from the event data 426) historic company revenue data and historic consensus adjustment data for a company associated with the stock price data and stock return data (e.g., a company from which the stock is issued). In accordance with aspects of the invention, the code 402 creates probabilistic models that predict future consensus adjustment and future stock return for the stock (i.e., for a future time after time t) based on the obtained historic stock price data, historic company revenue data, and historic consensus adjustment data (i.e., data prior to time t). In embodiments, the model that predicts future stock return for the stock is a probabilistic time series model that predicts a probabilistic distribution of a future value of a times series of the stock return.

In accordance with aspects of the invention, the distribution of tᵢₙ^{C} (i.e., time of a consensus adjustment) is parameterized by an event intensity parameter λᵢ^{C}(t), which predicts the probability density of the event happening at time t. In an embodiment, the module 411 models event intensity using a multivariate Hawkes process with domain knowledge using the entire history of the obtained consensus adjustment data. The Hawkes processes is a self-exciting process, where the occurrences of events will further increase the intensity of event happening. Embodiments use the multivariate Hawkes process (MHP), which extends this self-excitation to the mutual excitation of the events of different entities. In addition, based on both the domain knowledge and observation on the data, the consensus updates tend to be more frequent when they are close to the revenue release dates due to more information available and increased interests of investors. Therefore, embodiments adjust the intensity expression of the MHP model. In a particular example, the intensity parameter λᵢ^{C}(t) is modeled using Expression 4:

$${λ}_{i}^{C} ( t ) = {λ}_{i} + {\sum }_{j = 1}^{d} {\sum }_{n : {t}_{jn}^{C} < t} {α}_{i \vert j} g ( t - {t}_{jn}^{C} ; {w}_{i \vert j} ) + {α}_{i}^{+} g ( {t}_{i}^{+} - t ; {w}_{i}^{+} ) + {α}_{i}^{-} g ( t - {t}_{i}^{-} ; {w}_{i}^{-} ) \qquad ( 4 )$$

In Expression 4, g(⋅;w) is a nonnegative triggering kernel parametrized by w. In Expression 4, tᵢ⁺ and tᵢ⁻ denote the time of the next/last revenue release at time t, respectively. In accordance with an embodiment, the first two terms of this expression come from an initial MHP model, while the last two terms are added in accordance with aspects of the invention to account for the adjustment as discussed above. Expression 4 thus constitutes a novel MHP model. Embodiments consider two triggering kernels for g, with an exponential decay triggering kernel shown in Expression 5 and a sigmoid decay triggering kernel shown in Expression 6:

$$g ( t ; w ) = exp ( - t / w ) / w \qquad ( 5 )$$

$$g ( t ; w ) = \frac{{e}^{w}}{{e}^{t} + {e}^{w}} \qquad ( 6 )$$

According to aspects of the invention, the module 411 learns parameters αᵢ, αᵢ⁺, αᵢ⁻ of Expression 4 using machine learning and the obtained historic event data (e.g., historic consensus adjustment data for this asset, e.g., from event data 426). One non-limiting example of such machine learning utilizes maximum likelihood estimation (MLE) algorithms to determine the parameters αᵢ, αᵢ⁺, αᵢ⁻ based on the obtained historic event data for this particular asset. In this example, the log-likelihood for the model is given by Expression 7:

$$log L ( λ , α , w ) = {\sum }_{i = 1}^{d} {\sum }_{n = 1}^{{N}_{i}^{C}} log {λ}_{i}^{C} ( {t}_{i n}^{C} ) - {\sum }_{i = 1}^{d} {\int }_{0}^{T} {λ}_{i}^{C} ( t ) dt \qquad ( 7 )$$

In Expression 7, Nᵢ^{C} denotes the number of consensus events for company i. In embodiments, the learning algorithms are configured to penalize α_{i|j} with a regularizer to impose the sparsity.

In embodiments, by learning the parameters αᵢ, αᵢ⁺, αᵢ⁻ of Expression 4, the system creates a new model that may be used to predict the event intensity parameter λᵢ^{C}(t), which predicts the probability density of the event (e.g., consensus adjustment for this asset) happening at time t which may include a future time.

Still referring to FIG. 4, in an embodiment the module 412 models the distributions of consensus magnitude and revenue magnitude based on their previous event magnitudes. Embodiments assume that the magnitudes do not depend on the event intensities at the time when the events happen; also, unlike the event intensity model, embodiments do not consider the inter-dependencies of magnitudes among different companies, although the model can be extended to consider such interference and other external information.

Under the liquid market assumption, the consensus magnitude should reflect the market expectation on the revenue of the company. This means the last consensus magnitude should be the most accurate market estimate for the revenue, as long as there is at least one consensus update after the last revenue release. Therefore, given the last consensus value Cᵢ(tᵢₙ^{Z}), embodiments assume that the revenue Zᵢₙ follows a normal distribution centered at value Cᵢ(tᵢₙ^{Z}) with variance of value (σᵢ^{Z})² as represented by Expression 8:

Zᵢₙ| [symbol] (tᵢₙ)˜ [symbol] (Cᵢ(tᵢₙ^{Z}), (σᵢ^{Z})²) (8)
In Expression 8, Zᵢₙ represents the magnitude of the revenue release and H(tᵢₙ) represents the historical observations of this revenue release data up to the present time (e.g., obtained from event data 426).

In embodiments, if there is no consensus change after the last revenue release, the method uses the last revenue magnitude as the mean, and the distribution of revenue Zᵢₙ is given by Expression 9:

Zᵢₙ| [symbol] (tᵢₙ)˜ [symbol] (Zᵢ(tᵢₙ^{Z}), (σᵢ^{Z})²) (9)

In embodiments the second module 412 models the distribution of the consensus magnitude based on historic consensus adjustment data according to Expression 10:

Cᵢₙ| [symbol] (tᵢₙ)˜ [symbol] (μᵢₙ^{C}, (σᵢ^{C})²) (10)
In Expression 10, Cᵢₙ represents the magnitude of the consensus adjustment and H(tᵢₙ) represents the historical observations of this consensus adjustment data up to the present time (e.g., obtained from event data 426). The mean in Expression 10 is given by Expression 11:

μᵢₙ^{C}=C_{i,n-1}+α(Zᵢ(tᵢₙ^{C})−C_{i,n-1})1[τᵢ^{C}(tᵢₙ)<τᵢ^{Z}(tᵢₙ)] (11)
In Expression 11, Zᵢ(tᵢₙ^{C}) represents the last revenue value announced before time tᵢₙ^{C}, and τᵢ^{C}(t) and τᵢ^{Z}(t) denote the time of the last consensus/revenue update before time t, respectively. In embodiments, if there is no revenue update after the last consensus update, the method assumes that the value of this consensus update will be centered around the last value; otherwise, this consensus update will be also affected by the revenue update that happens after the last consensus update. In embodiments, the system uses maximum likelihood estimation (MLE) algorithms to determine the parameter a based on the obtained historic event data for this particular asset.

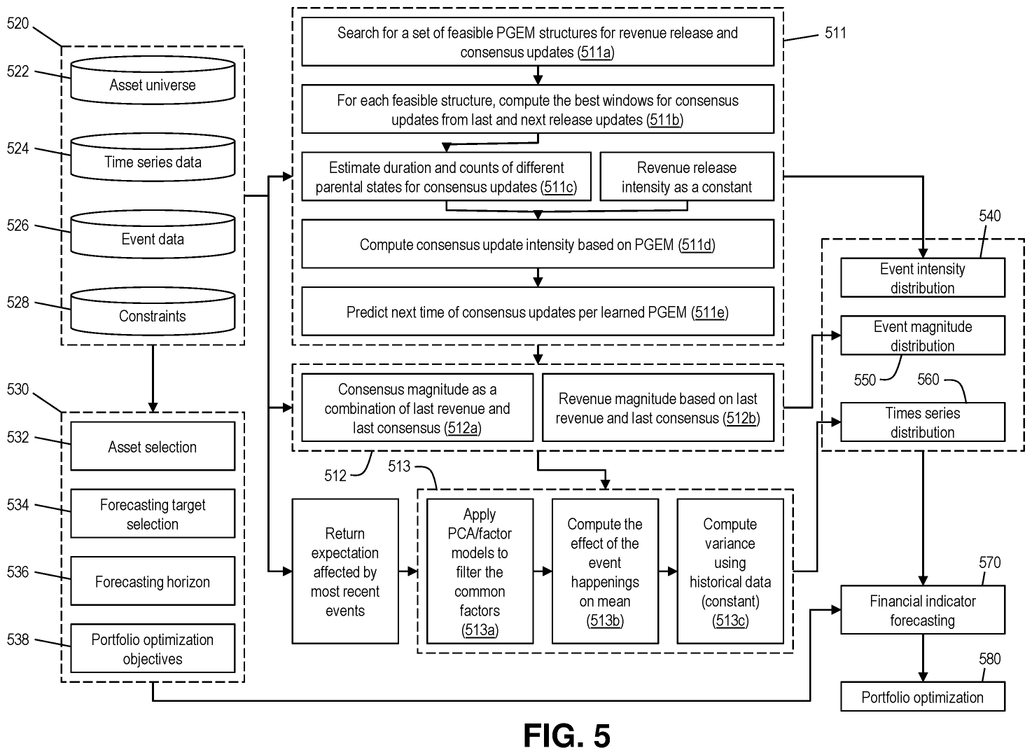

Still referring to FIG. 4, in an embodiment the module 413 models the stock price (or stock return) using a normal distribution with a jump upon events using a stochastic jump-diffusion process. In typical practice, stock return is usually modeled as normal distribution with constant mean and standard deviation for simplicity, i.e., Rᵢₜ˜N(μ0, pΣ), where the mean and the variance-covariance matrix are constant. This simple approach to modeling cannot capture the impact of dynamic events which often leads to negative skewed returns. Aspects of the invention address this shortcoming by providing models that incorporate effects of revenue release and consensus events to return modeling. A first modeling method is described with respect to module 413 of FIG. 4, and a second modeling method is described with respect to module 513 of FIG. 5.

In accordance with aspects of the invention, the module 413 generates a probabilistic time series model in a manner that accounts for the observation that stock prices become more volatile upon the event occurrences. Embodiments achieve this by using a stochastic jump-diffusion process for stock price modeling. In this example, the log-stock price follows the stochastic process according to Expression 12:

$$d log {S}_{i} ( t ) = {μ}_{i}^{R} dt + {σ}_{i} {dW}_{i}^{R} ( t ) + {\sum }_{j = 1}^{N} {k}_{i \vert j}^{C} ( t ) {dq}_{j}^{C} ( t ) + {\sum }_{j = 1}^{N} {k}_{i \vert j}^{Z} ( t ) {dq}_{j}^{Z} ( t ) , \qquad ( 12 )$$

In Expression 12, qᵢ^{C}(t) and qᵢ^{Z}(t) denote the counting process of consensus updates and earnings releases of company i, respectively, and the jump magnitude k_{i|j}^{C}(t) and k_{i|j}^{Z}(t) followed by a normal distribution that scales with the revenue surprise Pⱼ(t) or the consensus change Δⱼ(t) as shown by Expressions 13 and 14:

k_{i|j}^{Z}(t)˜ [symbol] (α_{i|j}^{Z}Pⱼ(t), β_{i|j}^{Z}Pⱼ²(t)) (13)

k_{i|j}^{C}(t)˜ [symbol] (α_{i|j}^{C}Δⱼ(t), β_{i|j}^{C}Δⱼ²(t)) (14)

In embodiments, the method obtains the marginal distribution for Rᵢ(t) as a Gaussian distribution with a mean according to Expression 15 and a variance according to Expression 16:

$${μ}_{i} ( t ) = {μ}_{i}^{R} + {\sum }_{j = 1}^{N} 1 \{ t = {τ}_{j}^{C} ( t ) \} {α}_{i \vert j}^{C} Δ j ( t ) + {\sum }_{j = 1}^{N} 1 \{ t = {τ}_{j}^{Z} ( t ) \} {α}_{i \vert j}^{Z} {P}_{j} ( t ) \qquad ( 15 )$$

$${υ}_{i} ( t ) = {σ}_{i}^{2} + {\sum }_{j = 1}^{N} 1 \{ t = {τ}_{j}^{C} ( t ) \} {β}_{i \vert j}^{C} {Δ}_{j}^{2} ( t ) + {\sum }_{j = 1}^{N} 1 \{ t = {τ}_{j}^{Z} ( t ) \} {β}_{i \vert j}^{Z} {P}_{j}^{2} ( t ) \qquad ( 16 )$$

In embodiments, based on the marginal distribution for Rᵢ(t) described above, the method utilizes the joint distribution of R(t) under the event models. In one example, the module 413 is configured to assume the correlation structure Θ among different companies does not change with time, and thus the joint distribution of R(t) under the event model is given by Expression 17:

R(t)˜ [symbol] (μ(t), Dᵥ₍ₜ₎^{1/2}ΘDᵥ₍ₜ₎^{1/2}) (17)
In Expression 17, Dᵥ(t) denotes the diagonal matrix of v(t). In embodiments, the method accounts for the financial factor model by performing principal component analysis (PCA) to filter the common factors and take the residual as the input of a learning framework. The module 413 then uses machine learning and the historic event data (e.g., from event data 426) to learn the model parameters α, β, and Θ for Expressions 15, 16, and 17. In one example, the module 413 uses a three-stage algorithm to learn the α's, β's and Θ one after another. In this example, the system learns the α's and β's using least squares algorithms with l1 penalty, and the system learns Θ using a thresholding operator algorithm. In embodiments, because the mean model (Expression 15) and the variance model (Expression 16) are learned separately in a sequential order, each model can be replaced by a more complicated/advanced model with event adjustments. For example, the module 413 can replace the constant variance σᵢ² in the variance expression vᵢ(t) with an ARCH or GARCH model, and learn the ARCH/GARCH part and the event adjustment β's in a two-stage fashion.

With continued reference to FIG. 4, the models generated by the code 402 can be used to perform event intensity forecasting at block 440, financial indicator forecasting at block 450, and portfolio optimization at block 460. In this manner, the system 400 of FIG. 4 provides a probabilistic framework that captures the impact of stochastic events (e.g., revenue release, consensus update, etc.) on finance time series, e.g., stock return, in a principled way. The system 400 uses a multivariate point process taking into account domain knowledge to learn the intensity of event occurrence. The system 400 also provides dynamic return variance-covariance estimation taking impact of event shocks. In this manner, the system 400 improves time series prediction and improves portfolio performance by incorporating stochastic event impacts.

In accordance with aspects of the invention, the system 400 of FIG. 4 comprises a cloud-based portfolio optimization system that includes a portfolio optimization engine that minimizes portfolio volatility, maximizes Sharpe ratio, etc., taking the simulation of financial time series over time. The cloud-based portfolio optimization system further includes a probabilistic framework that captures the impact of stochastic events on finance time series including: modeling event intensity via multivariate point processes with domain knowledge (e.g., via Expression 4); modeling event magnitude distribution by adjusting revenue/consensus mean upon consensus update events (e.g., via Expressions 8, 9, 10); and incorporating event impact into time series modeling by adjusting the mean of a time series model upon events as wells as variance-covariance of multivariate time series (e.g., via Expressions 15, 16, 17).

In accordance with aspects of the invention, the system 400 of FIG. 4 may be employed by a user (e.g., user 210a, 210b of FIG. 2) to predict financial time series via simulation using the learned time series models (e.g., via Expressions 15, 16, 17). In accordance with aspects of the invention, the user may utilize GUI 300 of FIG. 3 to specify which historical data the system 400 uses in generating the models described with respect to FIG. 4. For example, the user may utilize the GUI 300 of FIG. 3 to provide input to specify an asset selection 432, forecasting target selection 434, forecasting horizon 436, and portfolio optimization objectives 438 as shown in FIG. 4. In response to receiving this user input, the system 400 obtains the relevant historical data from the repository 206a or 206b and generates the models (e.g., Expressions 4, 8, 9, 10, 15, 16, 17) using machine learning and the obtained data. After generating the models, the system 400 permits the user to provide input to utilize the models to perform financial indicator forecasting and portfolio optimization. In this manner, the user may use the GUI 300 to select and upload an asset list, forecast future prices/returns for each individual asset in the asset list using the models, and explain event shocks to the financial time series.

FIG. 5 shows a diagram of system 500 for portfolio optimization in accordance with aspects of the invention. In embodiments, the system 500 includes code configured to generate a probabilistic framework including probabilistic models including an event intensity model, an event magnitude model, and a stock return model. In embodiments, the code comprises modules including: a first module 511 configured to perform event intensity modeling using a proximal graphical event model (PGEM); a second module 512 configured to perform even magnitude modeling; and a third module 513 configured to perform stock return modeling that forecasts stock return time series data using a normal distribution and a mean that is adjusted based upon financial events as described herein. Each of the modules 511, 512, 513 may comprise one or more modules of the code of block 200 of FIG. 1 and may be executable by the processing circuitry 120 of FIG. 1 to perform functions described herein. In an embodiment, the code is part of the model builder 202 of FIG. 2. The code may include additional or fewer modules than those shown in FIG. 5. In embodiments, separate modules may be integrated into a single module. Additionally, or alternatively, a single module may be implemented as multiple modules.

In embodiments, the system 500 comprises data sources 520 including asset universe 522, time series data 524, event data 526, and constraints 528, which are the same as the similarly named items in FIG. 4. The system 500 may also utilize user inputs 530 that specify an asset selection 532, forecasting target selection 534, forecasting horizon 536, and portfolio optimization objectives 538, which are the same as the similarly named items in FIG. 4.

As described above with respect to FIG. 4, aspects of the invention parameterize the distribution tᵢₙ^{C} (i.e., time of a consensus adjustment) by an event intensity parameter λᵢ^{C}(t), which predicts the probability density of the event happening at time t. In the system 400 of FIG. 4, this intensity parameter λᵢ^{C}(t) is modeled using a multivariate Hawkes process. In the system 500 of FIG. 5, this intensity parameter λᵢ^{C}(t) is modeled using a proximal graphical event model (PGEM). Typical Hawkes processes assume every historical release would impact new consensus updates, which contradicts the intuition that only the most recent few revenue reports would be impactful in practice. Due to such a long historical influence, it is also very hard to interpret the learned process to pinpoint the exact factors that most influence new consensus updates. Therefore, the system 500 of FIG. 5 uses a different model, where the model of the intensity parameter λᵢ^{C}(t) is defined using the proximal assumption, which states that historical impacts on events only come from a short window in the most recent past. This assumption results in a proximal point process model, such as the proximal graphical event model (PGEM).

A typical PGEM denoted by M={G, W, Λ} consists of 3 components: (i) a graph G={V, E}, where edges Eᵢⱼ=1 if node Xᵢ is a cause event or a parent of node Xj, {Xi, Xj}∈V, (ii) a set of window function W, where each window wᵢⱼ∈W indicates the length of the recent history [t−wᵢⱼ, t) that Xᵢ would have an impact on Xⱼ, and (iii) a set of intensity functions λ_{i|u}∈Λ for each node Xᵢ, where u is the value of parent nodes of Xᵢ.

In contrast to a typical PGEM, embodiments utilize a PGEM that is configured to capture the dependencies of the exogenous future events on the current consensus release. In this embodiment, the module 511 searches for a set of feasible PGEM structures for revenue release and consensus updates (e.g., at block 511a). In one example, wᵣ₋ and wᵣ₊ define two windows to past and future revenue reports from consensus update. In this example, the method only considers consensus here and drops index c from wᵣ. In this embodiment, t⁻ and t⁺ are the times for the most recent past and future revenue reports at time t, respectively. This example assumes that intensity parameter λᵢ^{C}(t) (also called consensus update rate or intensity rate) at any given time t depends on whether a duration of wᵣ₋ has passed since t⁻ and whether t⁺ would be reached within wᵣ₊ from t. Based on this, the intensity rate λᵢ^{C}(t) can be written as λ_{i|u}^{C}, where u is the actual values of the causal factors for consensus updates. For example, if both past and future revenue report are the causal factors (or parent nodes in PGEM), then the intensity rate λ_{iτ|-+}^{C} signifies the rate at which event c occurs at any time τ given that event r has occurred at least once in the interval [τ−wᵣ₋, τ) (hence −) and that r will not occur in [τ, τ+wᵣ₊) (hence +).

According to aspects of the invention, the module 511 learns graph G, window W, and intensity rates Λ in the PGEM. In embodiments, the module 511 first learns window W and intensity rates Λ using a given graph G. In one example, given one particular graph, the module 511 optimizes window W and intensity rates Λ by maximizing the log likelihood function shown in Expression 18:

$$log L ( {D}_{i}^{C} ) = {\sum }_{\vert u} ( - {λ}_{i \vert u}^{C} D ( u ) + N ( c ; u ) ln ( {λ}_{i \vert u}^{C} ) ) + {\sum }_{n = 1}^{N} log p ( {C}_{i n} ) \qquad ( 18 )$$

In Expression 18, N(c; u) is the number of times that c is observed in the dataset and that the condition u (from 2^{|U|} possible parental combinations) is true in the relevant preceding or future windows. In Expression 18, D(u) is the duration over the entire time period where the condition u is true. In this example, N(c; u) and D(u) are modeled as shown in Expressions 19 and 20:

$$N ( c ; u ) = {\sum }_{i = 1}^{N} 1 [ {l}_{i} = c ] {1}_{u}^{{w}_{r}} ( {t}_{i} ) \qquad ( 19 )$$

$$D ( u ) = {\sum }_{i = 1}^{N + 1} {\int }_{{t}_{i - 1}}^{{t}_{i}} {1}_{u}^{{w}_{r}} ( t ) dt \qquad ( 20 )$$

In these expressions, 1 [⋅] is an indicator function, which takes value 1 if the condition is true and 0 otherwise. In these expressions, 1ᵤ^{wr}(t) is an indicator for whether u is true at time t as a function of the relevant windows wᵣ. From Expression 18, it can be seen that the maximum likelihood estimates of the conditional intensity rates are as \hat{λ}_{C|u}=N(c; u)/D(u).

Window learning can be found exactly if C only has one parent in PGEM. For a node x with a single parent Z, the log likelihood maximizing window wzx either belongs to or is a left limit of a window in the candidate set W*={\hat{t}_{zx}}∪ max{\hat{t}_{zz}}, where {\hat{t}} denotes inter-event times in the datasets. It can be seen that the counts change at the inter-events \hat{t}_{zz}, and they are step functions and therefore discontinuous at the jump points; this is the reason why the optimal window can be a left limit of an element in W*. Hence, one can search for the best window, which maximizes the log-likelihood, in the set W*. However, if c has more than one parent, the windows can be outside W*. An embodiment uses a heuristic to search parents' window values one at a time, conditioned on previous windows. In this manner, the module 511 may, for each feasible PGEM structure, compute the best windows for consensus updates from last and next release updates (e.g., at block 511b).

Graph structure learning can be done with a forward and backward search (FBS) procedure to compute the max Bayesian information criterion, defined for a PGEM according to Expression 21:

BIC(D_{c}ⁱ)=log L(D_{c}ⁱ)−ln(T)2^{|U|} (21)
In Expression 21, T is the total time horizon in the datasets and |U| is the size of c's parent set. In embodiments, the module 511 estimates duration and counts of different parental states for consensus updates (e.g., at block 511c). In one example, given the BIC score, the module 511 uses FBS to conduct a forward search first and initializes the parental set of c to be empty, and then iteratively add one candidates parent nod to see if the resulting parental set increases the BIC score with learned W and Λ. If it is better than the current best score, FBS keeps the new parental set and check the next candidate. It runs until all variables have been tested. Then in the backward search phase, FBS iteratively tests if each candidate variable in the current parental set can be removed, i.e., if the rest of parents give a better BIC score. If so, the candidate parent is removed. After checking all candidates, FBS returns the resulting parental set as the learned parents.

As can be understood from the preceding description, module 511 may be configured to model event intensity λ_{i|u}^{C} using a PGEM by performing window learning and graph structure learning using Expressions 18, 19, 20, 21. In embodiments, the module 511 performs the window learning and graph structure learning using machine learning with historic event data (e.g., obtained from the event data 526). In a particular example, the learning comprises parameter estimation, and the module 511 performs the parameter estimation using maximum likelihood estimation algorithms with the data obtained from the event data 526. In this manner, the module 511 models the event intensity in a way that captures the influence of revenue release on consensus updates. By using the PGEM learned in this manner, the module 511 may be used to compute the consensus update intensity based in the PGEM (e.g., at block 511d) and predict a next time of consensus updates per the learned PGEM (e.g., at block 511e). As described herein, the PGEM used by the module 511 explicitly considers future events, which differs from existing proximal models. In this manner, the model learned by the module 511 can be used to recover the relationships explicitly, and to generate a causal relationship graph.

Still referring to FIG. 5, in an embodiment the module 512 models the distributions of consensus magnitude and revenue magnitude based on their previous event magnitudes. This may be performed in the same manner as described with respect to FIG. 4, e.g., using Expressions 8, 9, 10, and 11. In this manner, the module 512 may be used to predict consensus magnitude as a combination of last revenue and last consensus (e.g., at block 512a) and to predict revenue magnitude based on last revenue and last consensus (e.g., at block 512b).

Still referring to FIG. 5, in an embodiment the module 513 models the stock price (or stock return) using a normal distribution with a mean that is adjusted based on events as described herein (e.g., revenue release and consensus update). As described above with respect to FIG. 4, in typical practice, stock return is usually modeled as normal distribution with constant mean and standard deviation for simplicity, i.e., Rᵢₜ˜N(μ0, pΣ), where the mean and the variance-covariance matrix are constant. This simple approach to modeling cannot capture the impact of dynamic events which often leads to negative skewed returns. Aspects of the invention address this shortcoming by providing models that incorporate effects of revenue release and consensus events to return modeling. A first modeling method is described with respect to module 413 of FIG. 4, and a second modeling method is described with respect to module 513 of FIG. 5.

According to aspects of the invention, the module 513 accounts for impacts of event occurrences on probabilistic stock price forecasting by assuming the return expectation is affected by the most recent events as shown in Expression 22:

$${μ}_{i} = {\sum }_{j , l} {α}_{ijl}^{Z} ( {Z}_{j} ( t ) - {C}_{j} ( {τ}_{j}^{-} ) ) 1 [ t = {t}_{j}^{-} + l ] + {\sum }_{j} {α}_{ij}^{C} ( {C}_{jn} - {C}_{j ( n - 1 )} ) 1 [ t = {t}_{jn}^{C} ] \qquad ( 22 )$$

In Expression 22, the parameters αᵢⱼₗ^{Z} and αᵢⱼ^{C} and are the coefficient of the impact of company j's release and consensus update on company i. In Expression 22, l denotes the number of days ahead of t, and tⱼₙ^{C} is the time of consensus update n. In embodiments, the module 513 performs principal component analysis (PCA) to filter the common factors and take the residual as the input of a learning framework (e.g., at block 513a) The module 413 then uses machine learning and the historic event data (from event data 426) to learn the model parameters αᵢⱼₗ^{Z} and αᵢⱼ^{C}. One non-limiting example of such machine learning utilizes maximum likelihood estimation (MLE) algorithms to determine the parameters αᵢⱼₗ^{Z} and αᵢⱼ^{C} based on the obtained historic event data for this particular asset. In this manner, the module 513 creates a model that computes the effect of an event happening on the mean of the predicted distribution of the stock price (or stock return) (e.g., at block 513b). In this particular model, the variance is a constant (e.g., as indicated at block 513c).

With continued reference to FIG. 5, as described herein, the module 511 may be used to create a model that models event intensity for an asset in the asset universe 522, and that model may be used to generate an event intensity distribution 540 for that asset. As also described herein, the module 512 may be used to create a model that models event magnitude for an asset in the asset universe 522, and that model may be used to generate an event magnitude distribution 550 for that asset. As further described herein, the module 513 may be used to create a model that models a time series for an asset in the asset universe 522, and that model may be used to generate a time series distribution 560 for that asset. With continued reference to FIG. 5, the distributions calculated using the models can be used to perform financial indicator simulation at block 570 and portfolio optimization at block 580. In this manner, the system 500 of FIG. 5 provides a probabilistic framework that captures the impact of stochastic events (e.g., revenue release and consensus update) on finance time series, e.g., stock return, in a principled way. The system 500 uses an explainable probabilistic model in the form of a PEGM to learn the intensity of event occurrence and to provide an explainable graphical representation of event causal relationship. The event intensity model may be based on interdependencies of the stochastic events within a short window of time. In this manner, the system 500 improves time series prediction, promotes AI trust for finance by providing an explainable causal relationship, and improves portfolio performance by incorporating stochastic event impacts.

In accordance with aspects of the invention, the system 500 of FIG. 5 comprises a cloud-based portfolio optimization system that includes a portfolio optimization engine that minimizes portfolio volatility, maximizes Sharpe ratio, etc., taking the simulation of financial time series over time. The cloud-based portfolio optimization system further includes a probabilistic framework that captures the impact of stochastic events on finance time series including: modeling event intensity via a novel PGEM that captures historical impacts on events within a short window of time in the most recent past (e.g., via Expressions 18, 19, 20); modeling event magnitude distribution by adjusting revenue/consensus mean upon consensus update events (e.g., via Expressions 8, 9, 10, 11); and incorporating event impact into time series modeling by adjusting the mean of a time series model upon events (e.g., via Expression 22).

In accordance with aspects of the invention, the system 500 of FIG. 5 may be employed by a user (e.g., user 210a, 210b of FIG. 2) to predict financial time series via simulation using the learned time series models (e.g., via Expression 22). In accordance with aspects of the invention, the user may utilize GUI 300 of FIG. 3 to specify which historical data the system 500 uses in generating the models described with respect to FIG. 5. For example, the user may utilize the GUI 300 of FIG. 3 to provide input to specify an asset selection 532, forecasting target selection 534, forecasting horizon 536, and portfolio optimization objectives 538 as shown in FIG. 5. In response to receiving this user input, the system 500 obtains the relevant historical data from the repository 206a or 206b and generates the models (e.g., Expressions 8, 9, 10, 18, 19, 20, 22) using machine learning and the obtained data. After generating the models, the system 500 permits the user to provide input to utilize the models to perform financial indicator forecasting and portfolio optimization. In this manner, the user may use the GUI 300 to select and upload an asset list, forecast future prices/returns for each individual asset in the asset list using the models, and explain event shocks to the financial time series.

According to aspects of the invention, for both systems 400 and 500 of FIGS. 4 and 5, after the system learns the parameters for the various models, the system may be used to predict future occurrence times of consensus updates and future values of return for a stock. This predicting of future values of return for a stock may be used in portfolio optimization (e.g., at blocks 460 and 580) to achieve a selected goal for a portfolio of assets. For example, a method of portfolio optimization may include: selecting assets (e.g., stocks) to be analyzed for a portfolio; selecting types of events to be utilized in the analysis; selecting a forecast horizon for the analysis; for each of the selected stocks, generating a respective probabilistic time series model that predicts a probability distribution of a return of the stock and that takes into account the effect of the selected events on the return of the stock (e.g., Expressions 17 or 22); and, for different allocations of the assets within the portfolio, running simulations using the generated probabilistic time series models and the different allocations to determine an allocation of the portfolio that optimizes a selected characteristic (e.g., minimizes portfolio volatility, maximizes Sharpe ratio, etc.) at the selected forecast horizon. The stocks to be analyzed may be selected via the field 326 of the GUI 300 of FIG. 3. The events to be utilized in the analysis may be selected via the menu 320 of the GUI 300 of FIG. 3. The characteristic to be optimized may be selected via the field 322 of the GUI 300 of FIG. 3. The forecast horizon may be selected via the field 324 of the GUI 300 of FIG. 3. After receiving the inputs described in this example, the system (400 or 500) may determine a portfolio of the selected assets that has the highest likelihood of optimizing the selected characteristic at the selected forecast horizon, and the system may provide output to the user (e.g., via the GUI 300 or another interface) that indicates the determined portfolio. In this manner, a user (e.g., user 210a or 210b) may utilize the system (400 or 500) to perform analyses of different portfolios (e.g., groups of assets) to achieve an optimization of a selected characteristic within a selected time horizon, whereon the analyses account for the impact that stochastic financial events have on the predicted future stock prices.

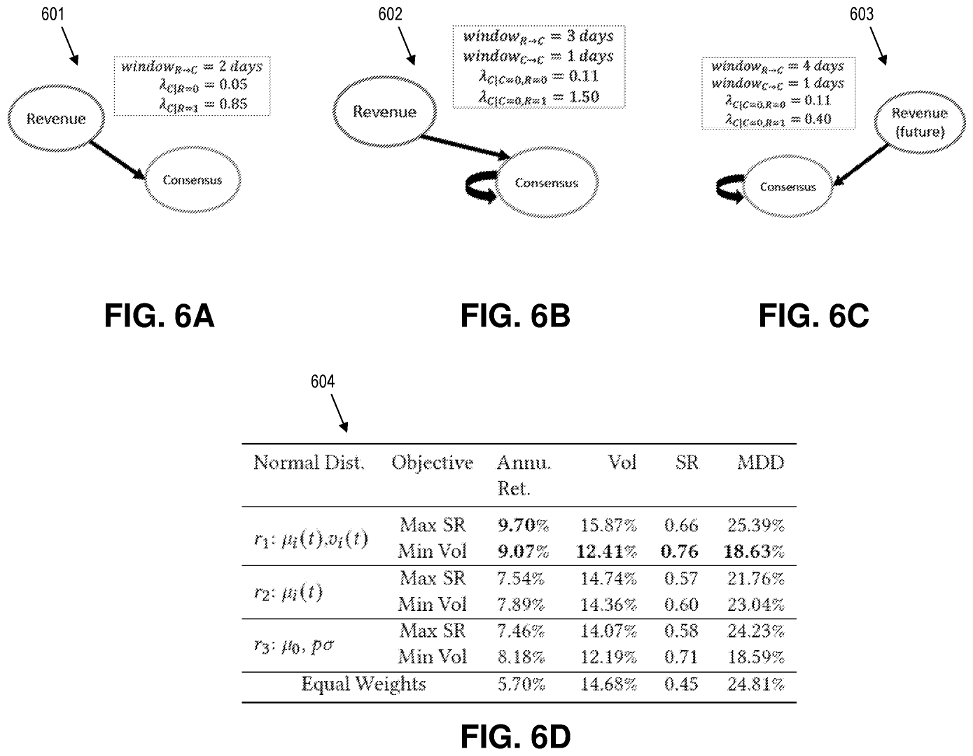

FIGS. 6A, 6B, and 6C show exemplary outputs comprising causal relationship graphs in accordance with aspects of the invention. The output may be presented in the GUI 300 of FIG. 3 or another GUI. In this example, FIGS. 6A, 6B, and 6C show visualizations of a learned graph structure for consensus change to illustrate event dependency. In embodiments, the system (e.g., system 400 or system 500) generates the causal relationship graphs based on the data resulting from simulations using historical data. In an exemplary use case, the simulations are generated using historical data for each of 508 publicly traded companies. In this use case, the historical data for each company includes quarterly revenue release date and value, consensus adjustment date and value, and daily closing market price of the stock of the company. In this use case, the historical data ranges from Jan. 2, 2007, to Aug. 31, 2019. In this use case, the data before Jan. 1, 2017, is used to learn the parameters of the models, e.g., in the manner described herein, and the data after Jan. 1, 2017, is used to evaluate model performance after learning the parameters. In this use case, after learning the parameters, the system uses the learned models to predict future occurrence time of consensus updates and future values of revenue, consensus, and return via 2000 runs of simulation. In embodiments, the system uses deep learning with the data resulting from simulations to learn (e.g., identify) patterns of causal relationships between the events (e.g., revenue release and consensus update), and the system generates causal relationship graphs (e.g., as shown at 601, 602, 603) based on these learned patterns.

FIG. 6A shows an example of a first causal relationship graph 601 that illustrates a learned dependency between revenue release and consensus change (e.g., also referred to herein as consensus update or consensus adjustment). The first causal relationship graph 601 indicates that when revenue release occurred in the past 2 days, a consensus change is more likely to occur, where the consensus change intensity (λ_{C|R=1}=0.85) is about 17 times of that (λ_{C|R=0}=0.05) if there are no revenue release occurred in the same window.

FIG. 6B shows an example of a second causal relationship graph 602 that illustrates a learned dependency between revenue release and consensus change. The second causal relationship graph 602 shows a similar influence of revenue release to consensus change (1.50 vs 0.11) as well as consensus change following its previous update. The second causal relationship graph 602 indicates that when revenue release occurred in the past 3 days, a consensus change is more likely to occur. The second causal relationship graph 602 indicates that when a consensus update occurred, another consensus change is likely to occur in the next day. The second causal relationship graph 602 indicates that the consensus change intensity is 0.11 if there is neither consensus change nor revenue release. The second causal relationship graph 602 indicates that the consensus change intensity is 1.50 if there is no consensus change but there is a revenue release.

FIG. 6C shows an example of a third causal relationship graph 603 that illustrates a learned dependency between revenue release and consensus change. The third causal relationship graph 603 shows that future revenue release impacts the rate of consensus update. The third causal relationship graph 603 indicates that four days before revenue release, a consensus change is likely to occur. The third causal relationship graph 603 indicates that when a consensus update occurred, another consensus change is likely to occur in the next day. The third causal relationship graph 603 indicates that the consensus change intensity is 0.11 if there is neither consensus change nor revenue release. The third causal relationship graph 603 indicates that the consensus change intensity is 0.40 if there is no consensus change but there is a revenue release.

FIG. 6D shows an exemplary output comprising portfolio performance in accordance with aspects of the invention. In an exemplary use case, a probabilistic framework (including the probabilistic models) is evaluated for event and return modeling via key performance indicators (KPIs) of simulated portfolios. In this use case, the probabilistic framework is created using the PGEM event intensity model (e.g., Expression 18 generated using the system 500 of FIG. 5) and its combination with variants of the return distribution models. The results of these models are used to create 2000 trials (e.g., simulations) of daily stock returns in the test period for each of plural companies, and to construct fully invested long-only portfolios that achieve a given objective, i.e., minimum volatility (Min Vol) or maximum Sharpe ratio (Max SR). The former reflects the robustness of dynamic variance-covariance prediction, while the latter brings return forecasting into the picture. Based on the projected portfolio returns, the system calculates four KPIs, i.e., annualized return (Annu. Ret), volatility (Vol), Sharpe ratio (SR), and maximum drawdown (MDD), as shown in Table 604. In this use case, two common practices are selected as baselines: 1) Equal Weights that distribute funding equally into all the stocks, which represents the market; and 2) r3 that portfolio returns are assumed as multivariate normal distribution with constant parameters.

As shown by Table 604 in FIG. 6D, for the respective portfolio optimization objective in this use case, the proposed model r1 performs the best which validates the benefits of taking into account dynamic event impacts in modeling both the mean and variance-covariance matrix of the return distribution. As shown by Table 604, keeping the variance-covariance matrix as constant as model r2, compared to r3, it is observed that Annu. Ret increases for Max SR but decreases for Min Vol. This implies that return prediction is improved by incorporating event impact but the accuracy of variance-covariance estimation is scarified. The baseline Equal Weights portfolio that neither impact of crucial events nor historical information is leveraged to predict future stock returns performs the worst considering all the 4 KPIs.

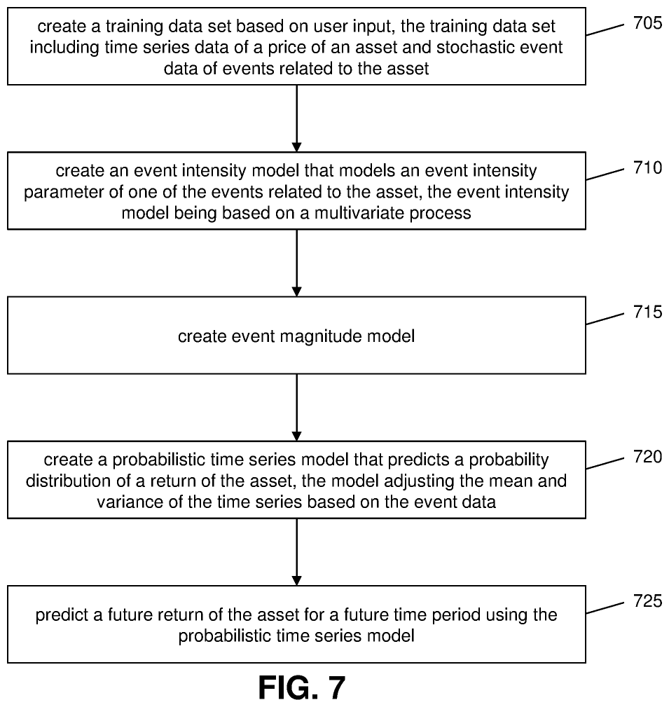

FIG. 7 shows a flowchart of an exemplary method in accordance with aspects of the present invention. Steps of the method may be carried out in the environment of FIG. 4 and are described with reference to elements depicted in FIG. 4.

At step 705, the system creates a training data set based on user input, the training data set including time series data of a price of an asset and stochastic event data of events related to the asset. In embodiments, and as described with respect to FIG. 4, the asset may comprise a stock of a company and the events may comprise quarterly revenue release for the company and consensus adjustment for the company. The user input may be received via the GUI 300 of FIG. 3. In embodiments, in response to receiving the user input, the system creates the training data set by obtaining historical data (e.g., from times series data 424 and event data 426), the historical data including quarterly revenue release date and value, consensus adjustment date and value, and daily closing market price of the stock of the company, for example.

At step 710, the system creates an event intensity model that models an event intensity parameter of one of the events related to the asset. In embodiments, and as described with respect to FIG. 4, the event intensity model is based on a multivariate process, in particular a novel multivariate Hawkes process, e.g., according to Expression 4. In embodiments, the creating the event intensity model comprises learning parameters of the event intensity model using machine learning and the training data set.

At step 715, the system creates an event magnitude model that models a distribution of magnitude of the events related to the asset based on previous magnitudes of the events related to the asset. In embodiments, and as described with respect to FIG. 4, the system creates the event magnitude models according to Expressions 8, 9, 10.

At step 720, the system creates a probabilistic time series model that predicts a probability distribution of a return of the asset. In embodiments, and as described with respect to FIG. 4, the probabilistic time series model and incorporates event impact into the time series modeling by adjusting the mean and the variance of the time series according to Expressions 15, 16, 17. In embodiments, the creating the probabilistic time series model comprises learning parameters of the probabilistic time series model using machine learning and the training data set.

At step 725, the system predicts a future return of the asset for a future time period using the probabilistic time series model. In embodiments, and as described with respect to FIG. 4, the system uses the probabilistic time series model to predict a probability distribution of a return of the asset at a future time period.

In embodiments, and as described herein, the probabilistic time series model is configured such that the predicted probability distribution of the return of the asset at a specific time comprises a normal distribution having a mean that is based on a stochastic jump-diffusion process. In embodiments, the mean and a variance of the normal distribution are each modeled using the stochastic event data, e.g., according to Expressions 15 and 16.

The method of FIG. 7 may include executing a portfolio optimization using the predicted future return of the asset. In embodiments, and as described herein, the executing the portfolio optimization may include: running simulations using the probabilistic time series model; and determining a portfolio, based on the simulations, that minimizes portfolio volatility or maximizes Sharpe ratio.

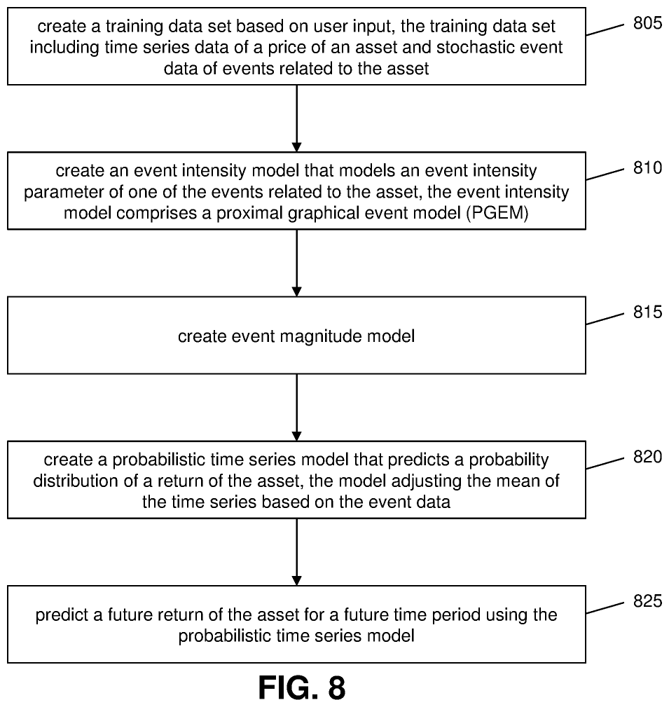

FIG. 8 shows a flowchart of an exemplary method in accordance with aspects of the present invention. Steps of the method may be carried out in the environment of FIG. 5 and are described with reference to elements depicted in FIG. 5.

At step 805, the system creates a training data set based on user input, the training data set including time series data of a price of an asset and stochastic event data of events related to the asset. In embodiments, and as described with respect to FIG. 5, the asset may comprise a stock of a company and the events may comprise quarterly revenue release for the company and consensus adjustment for the company. The user input may be received via the GUI 300 of FIG. 3. In embodiments, in response to receiving the user input, the system creates the training data set by obtaining historical data (e.g., from times series data 524 and event data 526), the historical data including quarterly revenue release date and value, consensus adjustment date and value, and daily closing market price of the stock of the company, for example.

At step 810, the system creates an event intensity model that models an event intensity parameter of one of the events related to the asset. In embodiments, and as described with respect to FIG. 5, the event intensity model comprises a proximal graphical event model (PGEM), e.g., according to Expression 18. In embodiments, the creating the event intensity model comprises learning parameters of the event intensity model using machine learning and the training data set.

At step 815, the system creates an event magnitude model that models a distribution of magnitude of the events related to the asset based on previous magnitudes of the events related to the asset. In embodiments, and as described with respect to FIG. 5, the system creates the event magnitude models according to Expressions 8, 9, 10.

At step 820, the system creates a probabilistic time series model that predicts a probability distribution of a return of the asset. In embodiments, and as described with respect to FIG. 5, the probabilistic time series model incorporates event impact into the time series modeling by adjusting the mean of the time series according to Expression 22. In embodiments, the creating the probabilistic time series model comprises learning parameters of the probabilistic time series model using machine learning and the training data set.

At step 825, the system predicts a future return of the asset for a future time period using the probabilistic time series model. In embodiments, and as described with respect to FIG. 5, the system uses the probabilistic time series model to predict a probability distribution of a return of the asset at a future time period.

In embodiments, the probabilistic time series model is configured such that the predicted probability distribution of the return of the asset at a specific time comprises a normal distribution having a mean that is adjusted based on the stochastic event data and a constant variance. In embodiments, the event intensity model is based on a time window of the stochastic event data that is less than all the stochastic event data.

The method of FIG. 8 may further comprise creating a causal relationship graph using the event intensity model. The method of FIG. 8 may further comprise executing a portfolio optimization using the predicted future return of the asset.

It can thus be understood from the description herein that implementations of the invention may be used to provide a computer-implemented method comprising creating a probabilistic framework that captures interdependencies among stochastic events, impacts of those respective stochastic events on a time series. The method may further comprise interpreting asset correlations by identifying causal relationships of crucial events. The method may further comprise predicting future values of assets based on received financial indicators.

It can be further understood from the description herein that implementations of the invention may be used to provide a computer-implemented method comprising: determining impact of stochastic events on a finance time series using a dynamic variance-covariance matrix by developing a set of probabilistic models, and learning historical impacts on events for a given time period (e.g., density of event occurrence and causal relationship); estimating asset risk based on the dynamic variance-covariance matrix; and optimizing a portfolio based on the estimated asset risk.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer 101 of FIG. 1, can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
creating, by a processor set, a training data set based on user input, the training data set including time series data of a price of an asset and stochastic event data of events related to the asset;
creating, by the processor set, a probabilistic framework for modeling event intensity, event magnitude, and their effects on a probabilistic time series of a return of the asset by:
creating, by the processor set, an event intensity model that models an event intensity parameter of one of the events related to the asset, wherein the event intensity model comprises a proximal graphical event model (PGEM), and wherein the creating the event intensity model comprises learning parameters of the PGEM using machine learning and the training data set; and
creating, by the processor set, a probabilistic time series model that predicts a probability distribution of a return of the asset, wherein the creating the probabilistic time series model comprises learning parameters of the probabilistic time series model using machine learning and the training data set; and
predicting, by the processor set, a future return of the asset for a future time period using the probabilistic time series model.

2. The method of claim 1, wherein the probabilistic time series model is configured such that the predicted probability distribution of the return of the asset at a specific time comprises a normal distribution having a mean that is adjusted based on the stochastic event data and a constant variance.

3. The method of claim 1, wherein the event intensity model is based on a time window of the stochastic event data that is less than all the stochastic event data.

4. The method of claim 1, further comprising creating a causal relationship graph using the event intensity model.

5. The method of claim 1, further comprising creating an event magnitude model that models a distribution of magnitude of the events related to the asset based on previous magnitudes of the events related to the asset.

6. The method of claim 1, wherein the asset is one of plural assets, and further comprising:
creating a respective event intensity model and probabilistic time series model for each of the plural assets; and
executing a portfolio optimization for a portfolio including the plural assets using respective predicted future returns of the plural assets.

7. The method of claim 1, wherein the stochastic event data comprises revenue release data related to the asset and consensus adjustment data related to the asset.

8. A computer program product comprising one or more computer readable storage media having program instructions collectively stored on the one or more computer readable storage media, the program instructions executable to:
create a training data set based on user input, the training data set including time series data of a price of an asset and stochastic event data of events related to the asset;
create a probabilistic framework for modeling event intensity, event magnitude, and their effects on a probabilistic time series of a return of the asset by:
creating an event intensity model that models an event intensity parameter of one of the events related to the asset, wherein the event intensity model comprises a proximal graphical event model (PGEM), and wherein the creating the event intensity model comprises learning parameters of the PGEM using machine learning and the training data set; and
creating a probabilistic time series model that predicts a probability distribution of a return of the asset, wherein the creating the probabilistic time series model comprises learning parameters of the probabilistic time series model using machine learning and the training data set; and
predict a future return of the asset for a future time period using the probabilistic time series model.

9. The computer program product of claim 8, wherein the probabilistic time series model is configured such that the predicted probability distribution of the return of the asset at a specific time comprises a normal distribution having a mean that is adjusted based on the stochastic event data and a constant variance.

10. The computer program product of claim 8, wherein the event intensity model is based on a time window of the stochastic event data that is less than all the stochastic event data.

11. The computer program product of claim 8, wherein the asset is one of plural assets and the program instructions are executable to:
create a respective event intensity model and probabilistic time series model for each of the plural assets; and
execute a portfolio optimization for a portfolio including the plural assets using respective predicted future returns of the plural assets.

12. The computer program product of claim 8, wherein the program instructions executable to create an event magnitude model that models a distribution of magnitude of the events related to the asset based on previous magnitudes of the events related to the asset.

13. The computer program product of claim 8, wherein the program instructions executable to execute a portfolio optimization using the predicted future return of the asset.

14. A system comprising a processor set, one or more computer readable storage media, and program instructions collectively stored on the one or more computer readable storage media, the program instructions executable to:
create a training data set based on user input, the training data set including time series data of a price of an asset and stochastic event data of events related to the asset;
create a probabilistic framework for modeling event intensity, event magnitude, and their effects on a probabilistic time series of a return of the asset by:
creating an event intensity model that models an event intensity parameter of one of the events related to the asset, wherein the event intensity model comprises a proximal graphical event model (PGEM), and wherein the creating the event intensity model comprises learning parameters of the PGEM using machine learning and the training data set; and
creating a probabilistic time series model that predicts a probability distribution of a return of the asset, wherein the creating the probabilistic time series model comprises learning parameters of the probabilistic time series model using machine learning and the training data set; and
predict a future return of the asset for a future time period using the probabilistic time series model.

15. The system of claim 14, wherein the probabilistic time series model is configured such that the predicted probability distribution of the return of the asset at a specific time comprises a normal distribution having a mean that is adjusted based on the stochastic event data and a constant variance.

16. The system of claim 14, wherein the event intensity model is based on a time window of the stochastic event data that is less than all the stochastic event data.

17. The system of claim 14, wherein the asset is one of plural assets and the program instructions are executable to:
create a respective event intensity model and probabilistic time series model for each of the plural assets; and
execute a portfolio optimization for a portfolio including the plural assets using respective predicted future returns of the plural assets.

18. The system of claim 14, wherein the program instructions executable to create an event magnitude model that models a distribution of magnitude of the events related to the asset based on previous magnitudes of the events related to the asset.

19. The system of claim 14, wherein the program instructions executable to execute a portfolio optimization using the predicted future return of the asset.

20. The system of claim 14, wherein the stochastic event data comprises revenue release data related to the asset and consensus adjustment data related to the asset.
